(19) United States
(12) Patent Application Publication
(10) Pub. No.: US 2010/0293486 A1
(43) Pub. Date: Nov. 18, 2010

(54) Website Optimisation System

(76) Inventor: Mark Baartse, Haberfield (AU)

Correspondence Address: Mark Baartse, 25 Northcote Street, Haberfield, 2045, omitted

(21) Appl. No.: 12/373,891

(22) PCT Filed: Feb. 20, 2008
(86) PCT No.: PCT/AU2008/000226

§ 371 Date: Jul. 28, 2010

(30) Foreign Application Priority Data
Feb. 22, 2007 (AU) 2007900911

(51) Int. Cl. G06F 3/048

(52) U.S. Cl. 715/763

(57) ABSTRACT

A method for producing self-dunnaged cathode bundles, comprising the steps of forming at least one deformed cathode by bending opposed ends of at least one cathode to form a pair of supports disposed at an angle to a central portion of the at least one deformed cathode, and stacking one or more further cathodes above or below the at least one deformed cathode.

### FIELD OF THE INVENTION

The invention relates generally to the field of web analytics, and in particular to systems and software applications for optimising a website on the basis of web traffic data collected in respect of visitors to website.

### BACKGROUND TO THE INVENTION

Websites are generally a group of interlinked web documents, including information in the form of text, hypertext links, images, sound, videos and other digital content, and are prepared and maintained as a collection of information by a person, group, or organisation. Websites are hosted on web servers which allow them to be accessible via the Internet or other similar network using devices such as computers, portable digital assistants (PDAs) and mobile phones.

An Internet “presence” has now become essential for businesses and organisations of all sizes, and central to this is a modern, well presented website which caters to the target market of the business or organisation. This is a particular requirement in relation to websites which have a specific call to action, such as ecommerce websites which allow visitors to purchase products and services directly from the website, or lead generation websites which attempt to get visitors details as sales prospects, etc. In such cases, a website which is well targeted and constructed in a manner that is conducive to making the visitors complete the desired action is likely to produce increased online transactions and greater results for the business.

Research in this area illustrates that something as simple as changing the colour of the “add to cart” button can measurably increase sales on an ecommerce website. Virtually any aspect of the website design or its content can have a positive or negative impact on completion of a desired action, such as a sale. Accordingly, it is desirable to optimise the design and construction of a website to maximise its performance.

In order to determine the effectiveness of alternative variations of a website's content, current optimisation methods attempt to scientifically measure the positive or negative impact of a particular alternative by placing it on the website and collecting data relating to the subsequent web traffic generated, with particular interest in the change in users behaviour. Such testing is typically done with software that presents multiple alternative variants of the website content, for example a button image version a, b or c, and headline copy a, b, or c, to different users and then collect data relating to the resulting web traffic. Once the testing process is completed, the resulting data is presented to a website designer for interpretation and who, on the basis of this data, is able to then technically implement the most effective website content, for example the best performing button and headline combination, on the website.

While this testing process is likely to be more effective than simply guessing the website content that will be most compelling to the target audience, it requires analysis of the website traffic data, and effort by a range of people including content and/or design specialists, technically skilled people, and possibly others, to create the elements required for the test, implement the necessary code on the website to conduct the test, interpret the data, implement the agreed on content, and remove the code required for the test from the website. Accordingly, this process can be labour intensive and thus quite expensive. Furthermore, this process becomes more expensive and time consuming as the amount of website content which is required to be tested increases, and as a result, the number of tests conducted is generally kept small and usually focus only on what are thought to be the most important elements of the website. This approach, however, may result in large amounts of the website content not being tested, and accordingly, crucial parts of the website which may need to be optimised may be missed.

One object of the invention is to provide a system and computer program for optimising websites without the extensive labour and expense associated with the prior art website optimisation processes.

A second object of the invention is to provide a system and computer program for optimising websites which provides an improved and more thorough means of testing and optimising a website.

### SUMMARY OF THE INVENTION

Broadly, the present invention provides a system and computer program for optimising a website wherein various alternatives of the website content are tested in order to determine which content and combination of content is optimal for producing the desired goals of the website (such as a sale), and the website content is automatically modified in accordance with these determinations.

Accordingly, in one aspect, the invention provides a system for optimising a website having a plurality of elements, the system including:

user interface means for allowing creation and/or selection of multiple alternatives of at least one website element;

testing means for allowing users access to the website wherein two or more alternatives of the website element are each presented to different website users;

data collection means for collecting data relating to the activity of each website user corresponding to the presentation of each alternative of the website element; and

processing means for determining the effectiveness of each alternative of the website element and modifying the website by deselecting at least one alternative of the website element;

whereby the determination of the relative effectiveness of each alternative of the website element is formed at least in part on the basis of the collected data, and the website is automatically modified in response to the determination.

The invention advantageously tests various aspects of the website content to determine how effective particular alternatives of the content are among users of the website, and automatically optimises the website to suit the results of this testing process, minimising the labour and technical skills normally involved in interpreting web traffic data and redesigning a website.

For example, in the current system, if a website author selects two different alternatives of a product image which is to appear on the website, ie image A and image B, a website including image A is presented to a first website user while a website including image B is presented to a second website user. The remainder of the website may be exactly the same, or in circumstances where a number of elements of the website content are being tested at once, the websites presented to the users may also include alternatives of other website elements, eg alternative versions of the product description text. Once the websites have been accessed by the users, data relating to each of the website users, eg the amount of time they accessed the website presented to them or whether they purchased a product, is collected and a determination is made as to which alternative(s) of the website element or elements are more effective. In the scenario where the website author is trying to encourage the user to spend a particular amount of time accessing the website, if the first user accesses the website for the desired amount of time but the second user does not, image A can be determined to be more effective than image B. In this simplified example, the system modifies the website on the basis of this determination so that all future users are presented with a website which includes image A rather than image B.

It is to be appreciated that while in the above example, each alternative of the website element is presented to a single website user, in practice it would be advantageous to present each alternative of a website element to a large number of website users so as to collect data which is statistically significant and realistically conveys the effectiveness of a particular alternative of the website element among website users generally.

Further, the system advantageously provides the ability to recursively optimise a website so that, based on the collected website user data, alternatives of website elements which are determined to be less effective than others can be progressively removed from the testing process and the website presented to users re-optimised until eventually, a single instance of each website element remains. In this way, wider and more thorough experimentation of website elements is likely to take place, leading to better results. Furthermore, by reducing the technical skills and time required, along with the associated costs, to create new tests, more tests on more aspects of the website content can be run. Additionally, when particular alternative(s) of a website element are determined to be less effective than others, the website can be modified to remove these alternatives, thus maximising the overall effectiveness of the website throughout out the optimisation process. In this way, situations where, for example, sales are lost due to some website users being presented with less effective alternatives of website elements for prolonged periods during optimisation of the website, ie even after the collected data illustrates that this is clearly the case, are minimised.

For example, in the current system, if a website author selects ten alternative descriptions of a particular product which is to appear on the website, ie description A through to description J, a website including description A is presented to a first website user while a website including description B is presented to a second website user, and so on. Once the websites have been accessed by the users, data relating to the website users is collected and a determination as to which alternative(s) of the website element or elements are most effective is made. In this simplified example, if the system determines that descriptions A to E are the most effective, the system modifies the website to remove the remaining descriptions from the website presented to users, and carries out further optimisation of the website using description A through to description E, so that all future website users are presented with a website which includes any one of descriptions A through to E, until one or more of these descriptions are removed. Ideally, this process continues until a single description remains which is determined to be the most effective.

It is also to be appreciated that while in the above example, all alternatives of the website element were each presented to different website users, before the website was modified, in some cases it may be advantageous to initially present only some alternatives of the website element to website users before modifying the website to remove those alternatives which are determined to be less effective. Further alternatives of the website element could then be subsequently presented to website users as required.

Preferably, the user interface allows the selection of a goal for the website users and the data collection means collects data relating to whether or not the goal is completed by each website user. Advantageously, this allows the website developer to indicate specific circumstances in which one alternative of a website element is determined to be more effective than another alternative.

For example, a website author may select two different alternatives of a product name which is to appear on the website, ie product name A and product name B, and indicate that the desired goal is the purchase of the product by the users. Where the product, when identified by product name A, is purchased by a greater proportion of users than when the product is identified using product name B, ie the correlation between product name A and fulfilment of the goal is higher, it can be determined that product name A is more effective than product name B.

Preferably, the testing means calculates a weighting for each alternative of the website element based on the collected data, and determines the proportion of website users presented with a particular alternative, at least in part, on the basis of the calculated weighting. In this way, alternatives of website elements can be presented to a progressively smaller proportion of users if it is determined that they are less effective than other alternatives, until eventually these ineffective alternatives are no longer presented to users and are automatically deselected and removed from the testing process. Similarly, alternatives of website elements can be presented to a progressively larger proportion of users if it is determined that they are more effective than other alternatives, until eventually the most effective alternative is presented to all users and the website is modified accordingly.

Preferably, the system includes tracking means for identifying a website user and collecting data relating to the website user across one or more accesses of the website by the website user. This provides a number of advantages including the ability to allow the system to determine the effectiveness of a particular alternative of a website element over a number of sessions (ie accesses of a website), or the effectiveness of different alternatives of the website element in relation to a particular website user when the website is accessed over a number of sessions by the website user.

For example, where the data collected relates to whether or not a predetermined goal was completed, the tracking means allows the system to track the website user's activity across a number of sessions and determine if the predetermined task was completed by the website user in any one of the sessions. In this way, the predetermined goal is marked as completed even where the user accesses the website one day, but does not complete the predetermined goal until the next day, ie the next time the user accesses the website. This will typically result in more accurate collection of data relating to the activity of website users.

In one form of the invention, the tracking means determines at least one demographic characteristic of the website user and on the basis of the characteristic, relates the alternative of the website element presented to the website user with the characteristic. In this way, the system allows testing of website elements across, for example, demographic groups.

In the above form of the invention, the determination of the relative effectiveness of each alternative of the website element is also formed on the basis of the characteristic, and the website is modified in response to the determination whereby a resulting first version of the website is associated with a first characteristic and a resulting second version of the website is associated with a second characteristic.

While certain elements, such as buttons, tend to be fairly generic and produce a similar response to all people, other elements, such as copy and images, will often result in different responses from persons of different demographics. For example, men and women will typically respond differently to different copy. By determining one or more characteristics of the user, such as age, sex, location, etc, the system is able to present particular alternatives of a website element to the person and therefore target the tests. In this way, ie by collecting data which is associated with particular demographics, and optimising the website on the basis of demographic characteristics of the user resulting in multiple versions of the website, for example one version per demographic group, the website is able to be better targeted to website users. One example of this is where a first version of the website is able to be accessed by male users, a second version of the website is able to be accessed by female users, while a third version of the website is accessed by users where the sex of the user cannot be determined.

In a preferred form, the tracking means includes a cookie located on the computer system of the website user.

Preferably, the system includes user interface for queuing website elements for testing in sequential order, thus allowing website elements to be tested individually one after another or in sequential groupings. The ability to queue website elements for testing allows a true ‘set and forget’ mechanism, wherein a website author is able to initially queue a large number of tests, knowing that they will be run when they are ready, and the results automatically implemented to optimise the website. For example, a non-technical site owner or website author could set up a wide range of tests which would take 6 months to gain enough data to be of statistical significance. The site owner or website author can continue with other work knowing that their tests will be run and the required modifications to the website implemented by the system without further intervention on their part.

It is further preferred that the user interface enables prioritisation of website elements whereby website elements of a higher priority are presented to website users for testing before website elements of a lower priority.

Preferably, the system includes process means for calculating an estimate of the time until testing for a particular website element is carried out and/or completed, and reporting means for reporting the estimated time.

Preferably, the system includes reporting means for generating reports on the collected data.

In another aspect, the invention provides a computer program for optimising a website having a plurality of elements, said computer program including computer instruction code for executing tasks including:

a) the creation and/or selection of multiple alternatives of at least one website element for presentation to website users;

b) allowing users access to the website wherein two or more alternatives of the website element are each presented to different website users;

c) collecting data relating to the activity of each website user corresponding to the presentation of each alternative of the website element;

d) determining the effectiveness of each alternative of the website element; and

e) modifying the website by deselecting at least one alternative of the website element;

whereby the determination of the relative effectiveness of each alternative of the website element is formed at least in part on the basis of the collected data, and the website is automatically modified in response to the determination.

Preferred and optional features of the computer program are in line with the preferred and optional features discussed in respect of the system discussed above.

The term website element is intended to be interpreted to broadly include any component of the website, including for example, headlines, descriptive copy, page layout, page text, products, product pricing and other attributes, design elements, colours used, font, downloads, etc. It is intended that any website component which can be seen by the users of the website is to be considered a website element. Furthermore, other website components, such as meta tag data, which may or may not be directly experienced are also intended to be included in the definition of a website element.

The term goal is intended to be interpreted to broadly to include any specifically defined action of the user which is desired. For example, a goal may be the purchase of an item in an ecommerce site, registration for an event, download of some software or document, subscription for a newsletter, etc. A goal would typically be achieved by reaching a specific page, such as the check out completion page or the “thank you for subscribing to our newsletter” page. However, a goal may also be completed by having a certain amount of profile data collected (which could be achieved through multiple steps or avenues of data collection), a particular set of web pages viewed, a certain amount of time spent on the site, the purchase being over a certain amount, etc.

### BRIEF DESCRIPTION OF THE DRAWINGS

Preferred and alternative embodiments of the present invention will be described with reference to the accompanying drawings, in which:

FIG. 1 is a conceptual diagram illustrating the system architecture of a preferred implementation of the present invention;

FIG. 2 is a flow chart illustrating the general process of optimising a website using the system of FIG. 1;

FIG. 3 is a flow chart illustrating the configuration process using the system of FIG. 1;

FIG. 4 is a screen shot of the goal setting aspect of the system of FIG. 1; and

FIG. 5 is a screen shot of the segment selecting aspect of the system of FIG. 1.

### DESCRIPTION OF PREFERRED EMBODIMENT

The present invention will be described with reference to particular implementations. These are intended to better explain implementations of the present invention, and are not intended to be limitative. It will be appreciated that the present invention is not limited to any particular operating systems or proprietary devices. Rather, the invention is at a more functional level. It should further be appreciated that the present invention can readily have further features added to it as the functionality of computer systems, and the costs thereof, change over time. All such additions and modifications fall within the scope of the present invention.

Furthermore, it is noted that the examples described below may need to be altered in detail or in substance, depending upon the specific capabilities and/or operating system of the particular computer systems used.

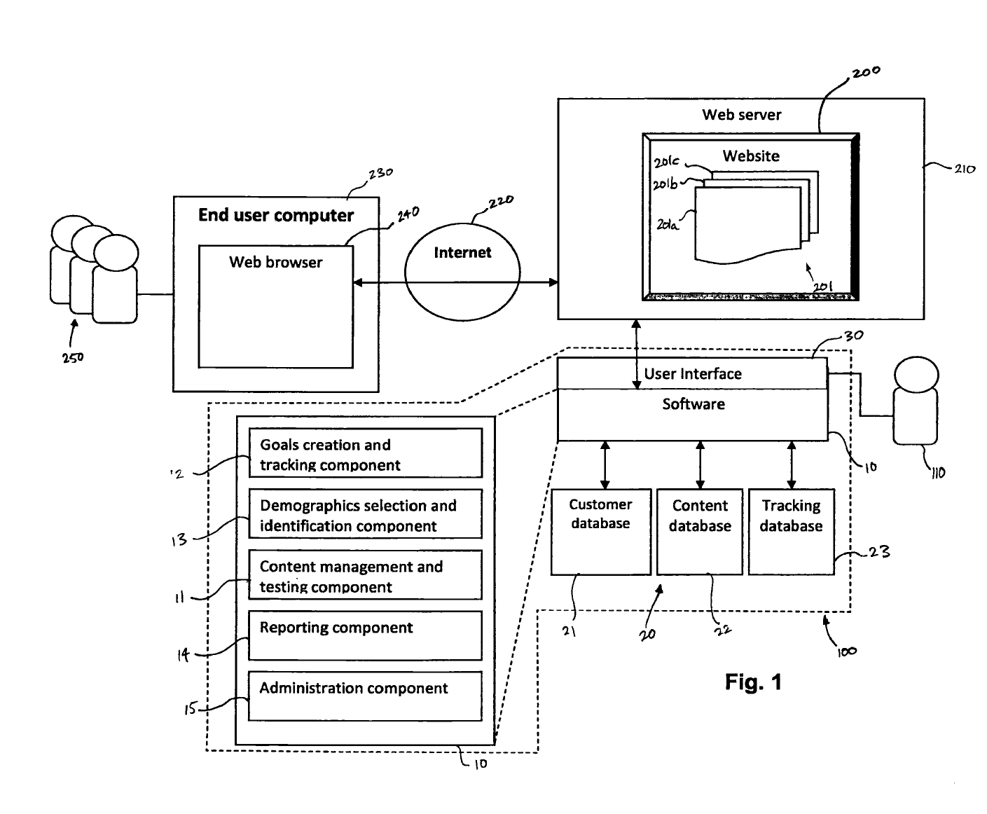

FIG. 1 is a conceptual drawing illustrating the logical components of a website optimisation system 100.

The system 100 includes software 10 for testing various elements 201 of a website 200 (discussed in further detail below) and modifying the website 200 on the basis of the testing process, database 20 for storing data relating to, for example, the website elements 201 and the users 250 of the website 200, and a user interface 30 for allowing a site author/administrator 110 to undertake tasks such as selecting website elements 201 for testing, defining goals which are used to determine the effectiveness of a particular alternatives of the website element(s) being tested.

The database 20 is preferably segmented into a user database 21 for storing and providing access to data relating to the activity of the users 250, a content database 22 for storing and providing access to data relating to the website elements 201 and a tracking database 23 for storing and providing access to data relating to the identification of the users 250 and their characteristics. It will be appreciated, however, that each of these distinct data stores may form different parts of a single database or a distributed database, or may in fact be separate databases, preferably with a linking identifier.

The system 100 communicates with a web server 210 to allow website users 250 to access and view the website 200 via an internet connection 220, and using a web browser 240 installed on the user's computer 230, or similar device such as portable digital assistant (PDA) or mobile phone.

The system 100 also communicates with the web server 210 to collect data relating to the activity of the user 250, such as the tasks carried out by the user 250 on the website 200, the specific web pages of the website 200 which were accessed, the amount of time the user 250 access the website 200 or particular parts of the website 200, etc.

It will be appreciated that the system may be implemented using server side and/or client side technologies. However, it is preferred the system 100 is implemented using server side technologies so as to avoid disadvantages of client-side technologies such as embedded JavaScript which increases page load time and fails in situations where users have JavaScript disabled.

The website 200 is designed and constructed to include a number of elements 201, or components, such as headings, text, images, etc. In the context of an ecommerce website which sells products, such elements may include the title of the product, the product description and an image of the product. The intention of the optimisation process is to determine the most effective alternatives of each website element 201, and to modify the website 200 accordingly so that the effectiveness of the resulting optimised website is maximised.

It will be appreciated that the system 100 can be adapted to test a single website element 201 at a time and modify the website 200 accordingly, or alternatively the system 100 is able to test multiple website elements 201 at the same time and modify the website 200 in accordance with the data collected and the effectiveness determinations reached.

In order to effect the optimisation process, some of the users 250 are able to access one particular version of the website 200, while other users 250 are able to access another version of the website 200. Similarly, a third group of users 250 may be directed to yet another version of the website 200, and so on. While these versions are likely to include the same website elements, they will differ in the fact that one or more of the website elements are distinct, le a different alternative of a website element is included in each version of the website 200.

For example, website 200 may include a website element 201 which may, for present purposes, be a product title. One version of the website 200 includes a first alternative 201a of the product title website element 201, while a second version of the website 200 includes a second alternative 201b of the product title website element 201, and a third version of the website 200 includes a third alternative 201c of the product title website element 201. Each alternative product title website element 201 makes reference to the same product, however, differences such as slightly different wording or the font in which the product title is displayed will be present between the various versions of the website 200.

It is to be appreciated that in some scenarios, one alternative of the website element 201 may be a blank, ie where the website element 201 is not viewable by a user when accessing the website 200. For example, where a website author/administrator 110 intends to determine whether or not a website including a product image will increase sales, one version of the website 200 including the product image is allowed to be access by some users 250, while a second version of the website 200 not including a product image is allowed to be accessed by other users 250.

The software 10 includes a content management and testing component 11 for selecting via the user interface 30, website elements 201 which are to be tested, and communicating with the web server 210 for allowing the users 250 to access particular versions of the website 200. Subsequently, the testing component 11 collects data relating to the activity of the users 250 corresponding to the alternatives of the website elements 201, and stores this information in database 20.

When optimisation of the website 200 is conducted, the system 100 communicates with the web server 210 to indicate the version of the website 200 to be accessed by some of the users 250 and the version of the website 200 to be accessed by some of the other users 250.

It is to be appreciated that the system 100 is able to communicate with more than one web server such that each additional web sever is a mirror of the web server 210. The site author/administrator 110 is also able to, using the goal creation and tracking component 12, set goals for users 250, the fulfilment of which are used to determine the effectiveness of particular alternatives. Also, the site author/administrator 110 is also able to, using the demographic selection and identification component 13, arrange tests according to characteristics of the users 250, and if required, generate various versions of the website 200, each directed at a particular segment of the users 250.

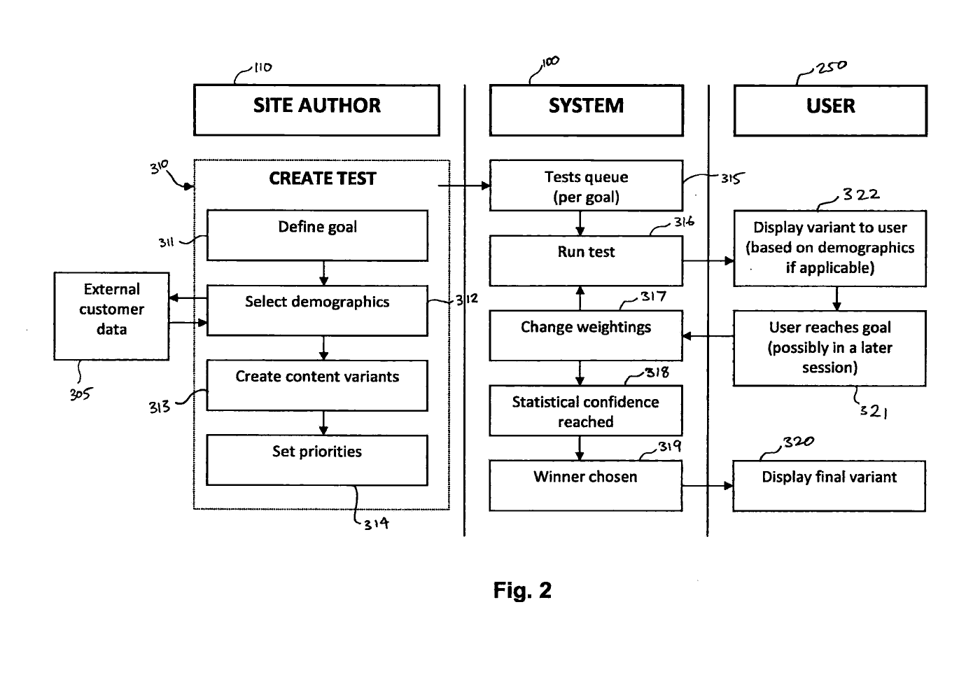

FIG. 2 demonstrates the overall working of the process. It covers the steps taken on the end to end process from the creation of a new test through to the completion of the test.

Where the site author/administrator 110 wishes to test two alternatives of the text describing a product for sale on an ecommerce site. The site author creates a test, illustrated generally at 310, by entering both versions of the text into the software 10 via the user interface 30 at step 313, and selecting the desired goal. These versions of the text are thus selected by the system 100 to take part in the testing process. Optionally, if interim results of previous testing are available, a summary of such results are able to be displayed to the site author/administrator 110 at this time to assist in the setup and goal setting process.

In an alternate embodiment, the elements and the alternatives of the elements to be tested are created outside the system 100 using for example, relevant code and/or an external content management system.

The system 100 runs the test at step 316 and presents at step 322 some of the users 250 with one version of the text and other users 250 with the second version of the text. The system 100 at step 321 monitors which of the users 250 completed the goal(s) as defined by the site author/administrator 110 (in this case, it would likely be purchase of the item). Once a sufficient amount of data is available on which a decision can be made as to which alternative is more effective, ie the alternative most likely to influence the user to complete the goal, based on a defined level of statistical confidence (step 318) (the desired level of statistical confidence would typically be defined system wide by the site author/administrator 110), the system 100 automatically, and without the need for further human intervention, deselects the less effective alternatives of the website content at steps 319 and displays at step 320 a version of the website 200 which includes the most effective alternative of the website content to all of the users 250.

It will be appreciated that less effective alternatives of website content may be deselected and removed from the website 200 at any stage in the testing process, or alternatively the software 10 may determine the most effective alternatives at the conclusion of the testing process and modify the website 200 at this time to include only the most effective alternative of the website content.

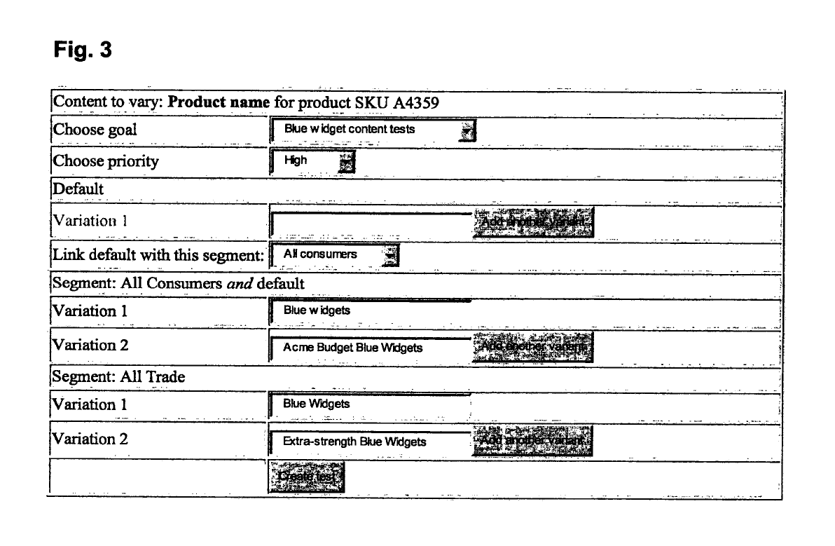

The ability to create multiple versions of the content is fully encompassed within the content management and testing component 11 of the software 10 in the system 100. Virtually every piece of content would potentially allow multiple alternatives to be created, although this could be restricted if desired by the site author/administrator 110 or site administrator. Some examples include, but are not be limited to, product images, product descriptions, product titles, product prices, shipping prices, site colours, number of products featured on the homepage, logo design, inclusion or exclusion of certain page elements (eg a “30 day money back guarantee” tag, or “hacker-free guaranteed” tag). Alternatives could be created inline as part of the normal operations of content management within the content management component 11 without having to interface or setup external software, engage technical staff, and so on. For example, when entering a product description, it is possible to create multiple product descriptions at the point of entry through the user interface 30, illustrated at FIG. 3. Each of these descriptions are incorporated in a website, each alternative of which is presented to the users 250 via the web server 210. One means of doing this is to rotate the different versions of the website so that one user is presented a version of the website, while a subsequent user is presented with the next version of the website, and so on.

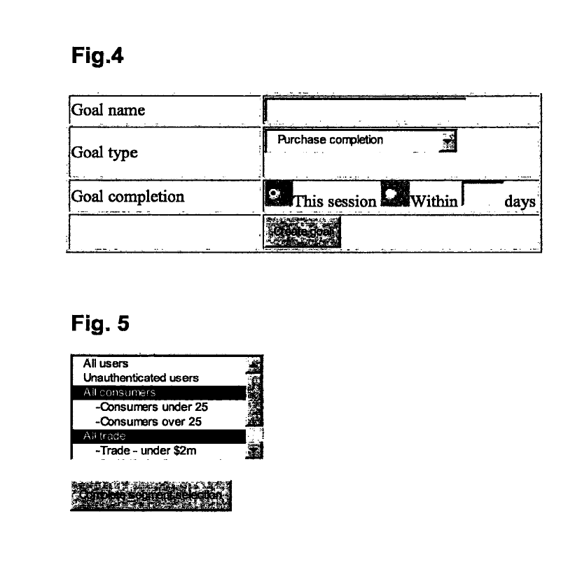

The effectiveness of each content alternative is measured by the system 100 based on the user achieving the predetermined goal, as identified by the site author/administrator 110 at step 311 and illustrated at FIG. 4. The relevant desired goal is associated with each website element, although many assumptions could be made. For example, for alternatives of a product title it is assumed that the goal is to increase sales of that particular product and therefore the successful goal is the purchase of that product. In such cases, the goal could be set automatically. Inclusion of a “free shipping for orders over $50” promotion would typically test the overall order size. A “hacker-free guaranteed” would typically test whether the user made an order at all. Based on the goals, the system 100 analyses the success of various website elements and automatically manages the rotation of the different versions of the website at step 317. For example, if three possible images for a product were entered as alternatives, the software 10 initially shows all images in a 33% rotation. If after a statistically significant number of goal completions, image A produced 1.8% sales, image B 1.4% sales and image C 2.3%, then the software 10 is able to adjust the weighting applied to the display of the different alternatives of the image so, for example, image A would be shown 30% of the time, image B 10% of the time, and image C 60% of the time. As the statistical confidence in the results grew, those percentages would continue to be weighted until the leading alternative of the image (image C likely in this case) was shown 100% of the time, at steps 318, 319, and 320. This weighting process occurs without the need for human intervention. It is also be possible to define the percentage of users being shown the various alternatives. For example, 70% of users could be shown the existing content, while the remaining 30% are shown the three test images in rotation. Rates of goal completion is then compared to the existing content and a “winner” chosen for presentation to all future users.

Preferably, the goal does not necessarily have to be achieved in the same session as the presentation of the content. It could be determined by the site author/administrator 110 (depending on the specific implementation) that it is acceptable for time to pass before completion of the goal. For example, it could be defined that completion of the goal within seven days of being shown the content variant would still be considered as completion of the goal by a user. This allows the goal to be optionally achieved over multiple sessions. In order to identify the user and track the activity of the user over multiple sessions, the goal creation and tracking component 12 of the software 10 places a cookie on the user's machine and accesses the information in the cookie when the user accesses the website 200. It is to be appreciated, however, that alternative implementations including a server store based on authentication, or some other cookie-like client side store are also capable of providing similar functionality.

Optionally, the system 100 integrates, at step 305, with existing available data in database 20. In this way, user segments can be defined as illustrated at step 312 and FIG. 5. These can be as simple as segments based on demographic characteristics such as geography, age, gender, buying history, etc, or as sophisticated as the organisation's data allows, such as a male 20-35 year old software developer living in Florida. The system 100 assumes that the segments have been created by an external system and plays no direct role in their creation, or alternatively such functionality could be provided in the system 100 via the user interface. Thus, alternatives of the website content, each targeted to specific segments, are able to be created. This would typically rely on the user being authenticated, or alternatively this data somehow being available such as via a cookie or click stream analysis, however any tracking technology could be used. Allowance would typically need to be made for users who are anonymous, ie where the data is unknown, for whom insufficient data is available or if they don't fall into a segment which has been targeted.

For example, if a product description is created for an ecommerce site, two variation tests would be setup. One test is aimed at female users, while the other is aimed at other users, which would include those known to be male, and those unknown. The site author would then create multiple versions of the text they believe would appeal to females and multiple versions they believe would appeal to males and/or general users. The system 100 puts these variants into rotation as previous described, and progressively change the weighting of them. After a period of time where the system 100 has reached the desired level of statistical confidence, all users known to be female are shown the text for which the greatest number of goals had been achieved by females. Males and those of unknown gender are shown the text deemed best for them.

It is preferred that too many test elements are not introduced simultaneously. If, for example, 50 elements across the site each with 3 alternatives each were being tested at the same time against the same goal, it would require an enormous amount of traffic out of the reach of virtually all sites, to produce a statistically significant result within a reasonable amount of time. Therefore, the software 10 is able to allow queuing of the website elements for testing in sequential order. In this way, the tests may also be sequenced where one aspect of a particular website element is tested after another aspect of the website element is tested. For example, if the website element being tested is a page heading, a first test may relate to the wording of the heading and when a particular heading is determined from the alternatives, a subsequent test may relate to the font in which the page heading is displayed. Similarly, further tests may relate to the colour of the page heading, its positioning on the website, etc. It will be appreciated that each of these aspects of the page heading are considered to be a website element which can be tested. Of course, once the optimal form of the page heading has been determined, further tests which relate to other components of the website can be run.

Alternatively, the software 10 optionally allow the site author/administrator 110 to select a priority for each element being tested at step 314, with high priority elements being placed in front of the queue at step 315 and lower priority elements not being tested until statistical confidence was reached in the higher priority elements.

Preferably, the reporting component 14 of the software 10 reports which present estimates of number of transactions needed are made available, and if sufficient historical data exists, the estimated amount of time to achieve that number of transactions, in order for site authors/administrators 110 to make appropriate decisions and not to end up in a scenario where a test would take an unrealistically long time (for example, several years) to complete. In such cases a queue is also able to be setup for each goal set. Therefore, each website element being tested is able to be associated with a specific goal. Multiple tests could run on the site simultaneously with different goals. It is to be appreciated that if the user accesses a website including an alternative of a particular website element being tested for goal A and instead completes goal B, the content associated with goal A has no bearing on the measurement of the completed goal B.

Similarly, the reporting component 14 of the software 10 generates reports outlining the results of the optimisation process may also be accessed by the site authors/administrators 110 for informational purposes.

Another more sophisticated optional implementation allows the site administrator to define a global setting such as “I want tests to run no longer than X”, where X is a definable amount of time, typically a few days to a few weeks. The system 100 then runs as many tests as it is confident it can run in that time period. This requires an existing body of data in the database 20 to provide the software 10 with sufficient information about typical traffic to the sections being tested and typical goal attainment rates, in order to make an estimate. This time factor is added into the test queuing aspect of the content management and tracking component 11 of the software 10.

It is also envisioned that system 100 could implement and test content originating in an RSS feed, delivered via email, or any other content delivery technique. The key difference in those methods is that the variations have to be embedded in the content as sent out to the user and that there is no opportunity to vary the content once sent. Nevertheless, it is still possible to associate goals with content elements, report on the goal attainment rates of those various elements, which is able to provide useful data for future deliveries.

It will be appreciated that the present invention may be implemented on a variety of platforms, with additions and variations enabled by the device chosen, and the application required.

1. A system for optimising a website having a plurality of elements, the system including:
user interface means for allowing creation and/or selection of multiple alternatives of at least one website element;
testing means for allowing users access to the website wherein two or more alternatives of the website element are each presented to different website users;
data collection means for collecting data relating to the activity of each website user corresponding to the presentation of each alternative of the website element; and
processing means for determining the effectiveness of each alternative of the website element and modifying the website by deselecting at least one alternative of the website element;
whereby the determination of the relative effectiveness of each alternative of the website element is formed at least in part on the basis of the collected data, and the website is automatically modified in response to the determination.

2. A system according to claim 1, wherein the user interface allows the selection of at least one goal for the website users and the data collection means collects data relating to whether or not the predetermined goal is completed by each of the website users.

3. A system according to claim 1 or 2, wherein the testing means calculates a weighting for each alternative of the website element based on the collected data, and determines the proportion of website users presented with a particular alternative, at least in part, on the basis of the calculated weighting.

4. A system according to any one of claims 1 to 3, wherein the system includes tracking means for identifying a website user and collecting data relating to the website user across one or more accesses of the website by each website user.

5. A system according to claim 4, wherein the tracking means determines at least one demographic characteristic of the website user and on the basis of the characteristic, relates the alternative of the website element presented to the website user with the characteristic.

6. A system according to claim 5, wherein the determination of the relative effectiveness of each alternative of the website element is also formed on the basis of the characteristic, and the website is modified in response to the determination whereby a resulting first version of the website is associated with a first characteristic and a resulting second version of the website is associated with a second characteristic.

7. A system according to any one of claims 4 to 6, wherein the tracking means includes a cookie located on the computer system of the website user.

8. A system according to any one of the previous claims, wherein the system includes user interface for queuing website elements for testing in sequential order.

9. A system according to claim 8, wherein the user interface enables prioritisation of website elements whereby website elements of a higher priority are presented to website users for testing before website elements of a lower priority.

10. A system according to any one of the previous claims, wherein the system includes process means for calculating an estimate of the time until testing for a particular website element is carried out and/or completed, and reporting means for reporting the estimated time.

11. A system according to any one of the previous claims, wherein the system includes reporting means for generating reports on the collected data.

12. A computer program for optimising a website having a plurality of elements, said computer program including computer instruction code for executing tasks including:
a) the creation and/or selection of multiple alternatives of at least one website element for presentation to website users;
b) allowing users access to the website wherein two or more alternatives of the website element are each presented to different website users;
c) collecting data relating to the activity of each website user corresponding to the presentation of each alternative of the website element;
d) determining the effectiveness of each alternative of the website element; and
e) modifying the website by deselecting at least one alternative of the website element;
whereby the determination of the relative effectiveness of each alternative of the website element is formed at least in part on the basis of the collected data, and the website is automatically modified in response to the determination.

13. A computer program according to claim 12, wherein the user interface allows the selection of at least one goal for the website users and the data collection means collects data relating to whether or not the predetermined goal is completed by each of the website users.

14. A computer program according to claim 12 or 13, wherein the computer program includes computer instruction code for calculating a weighting for each alternative of the website element based on the collected data, and determining the proportion of website users presented with a particular alternative, at least in part, on the basis of the calculated weighting.

15. A computer program according to any one of claim 12 or 14, wherein the computer program includes computer instruction code for tracking and identifying a website user, and collecting data relating to the website user across one or more accesses of the website by each website user.

16. A computer program according to claim 15, wherein the computer instruction code for tracking and identifying a website user determines at least one demographic characteristic of the website user and on the basis of the characteristic, relates the alternative of the website element presented to the website user with the characteristic.

17. A computer program according to claim 16, wherein the determination of the relative effectiveness of each alternative of the website element is also formed on the basis of the characteristic, and the website is modified in response to the determination whereby a resulting first version of the website is associated with a first characteristic and a resulting second version of the website is associated with a second characteristic.

18. A computer program according to any one of claims 15 to 17, wherein the computer instruction code for tracking and identifying a website user, includes a cookie located on the computer system of the website user is using to access the website.

19. A computer program according to any one of claims 12 to 18, wherein the computer program includes computer instruction code for queuing website elements for testing in sequential order.

20. A computer program according to claim 19, wherein the computer instruction code enables prioritisation of website elements whereby website elements of a higher priority are presented to website users for testing before website elements of a lower priority.

21. A computer program according to any one of claims 12 to 20, wherein the computer program includes computer instruction code for calculating an estimate of the time until testing for a particular website element is carried out and/or completed, and for reporting the estimated time.

22. A computer program according to any one of claims 12 to 21, wherein the computer program includes computer instruction code for generating reports on the collected data.

23. A system and computer program for optimising a website substantially as herein described with reference to any one of the accompanying drawings.
